(19) United States
(12) Patent Application Publication
(10) Pub. No.: US 2026/0070596 A1
(43) Pub. Date: Mar. 12, 2026

(54) HARDTOP STORAGE DEVICE

(71) Applicant: LANGE ORIGINALS, LLC, Salt Lake City, UT (US)

(72) Inventors: Carter Smith, Salt Lake City, UT (US); Tobin Gunderson, Salt Lake City, UT (US)

(73) Assignee: LANGE ORIGINALS, LLC, Salt Lake City, UT (US)

(21) Appl. No.: 19/327,981

(22) Filed: Sep. 12, 2025

Related U.S. Application Data
(60) Provisional application No. 63/693,948, filed on Sep. 12, 2024.

(51) Int. Cl. B62B 3/10; B60J 7/10

(52) U.S. Cl. CPC B62B 3/10; B60J 7/106

(57) ABSTRACT

Disclosed is a hardtop storage device that includes a central frame, a first side frame, and a second side frame. The central frame includes a first support arm, a second support arm, and a wheel. The support arms both include a brace. The first side frame attaches to the first end of the central frame. The second side frame attaches to the second end of the central frame. The first and second side frames include a bend, a wheel, and a horizontal branch.

### PRIORITY CLAIM

This application claims the priority and benefit of United States Provisional Patent Application No. 63/693,948 filed on Sep. 12, 2024, which is incorporated by reference in its entirety.

### BACKGROUND

The history of carts and wagons with removable tops is deeply rooted in the evolution of transportation, dating back to ancient times when these vehicles were essential for trade, agriculture, and personal travel. The development of removable tops on carts and wagons reflects users adapting to varying environmental conditions and diverse needs.

Carts and wagons have been used since ancient times, with evidence of their existence in Mesopotamia, Egypt, and other early civilizations. These early vehicles were typically open-topped, made from wood, and pulled by animals such as horses, oxen, or donkeys. The open design of these carts and wagons was practical for carrying goods and people but offered no protection from the elements.

As societies grew and trade routes expanded, the need for protection from the weather became more pressing. This led to the development of basic coverings, such as fabric or animal skins, that could be draped over the carts or wagons. These coverings were often tied down or fastened in a rudimentary fashion, providing shelter from rain, sun, and wind but were not easily removable or adjustable. During the Medieval and Renaissance periods, carts and wagons became more sophisticated in both design and function.

In Europe, the development of the covered wagon, also known as a carriage, marked a significant advancement. These wagons featured arched wooden frames covered with canvas or leather, creating a more durable and weather-resistant enclosure. The tops of these wagons were often designed to be removable or adjustable, allowing for greater versatility. For example, when traveling in fair weather or during the summer, the canvas covers could be rolled up or removed entirely to allow for ventilation and visibility. Conversely, during inclement weather, the covers could be securely fastened to protect the occupants and cargo. Covered wagons were especially popular among merchants, travelers, and settlers, as they provided a practical solution for long journeys across diverse terrains and climates.

The design of these wagons was highly adaptable, with variations emerging in different regions to suit specific needs, such as the Conestoga wagon in North America, which played a crucial role in westward expansion. The 19th century saw further developments in the design of carts and wagons with removable tops, particularly in the context of the American frontier. The iconic “prairie schooner” or “covered wagon” became synonymous with the westward migration of settlers in the United States. These wagons were designed with large, curved wooden bows that supported a canvas cover, which could be easily removed or adjusted depending on the weather conditions. The removable tops of these wagons were essential for the long and arduous journeys across the plains, protecting them from the harsh sun, rain, and wind. The design allowed for flexibility, as the covers could be rolled back during the day to allow for airflow and then secured tightly at night or during storms. The use of removable tops on wagons extended beyond just protection from the elements. They also served as a means of privacy for the occupants, as well as a deterrent against theft and wild animals. The design of these wagons was practical, durable, and suited to the rugged conditions of frontier life.

In the 20th century, during the infancy of the automobile, vehicles during this period were often modeled after horse-drawn carriages and frequently featured open-air designs with fabric covers that could be manually removed or retracted. These early designs, however, were rudimentary, often lacking in durability and ease of use. As automobiles became more advanced, the desire for enclosed vehicles grew, especially as a means to protect occupants from the elements. This led to the development of fixed roofs, which offered improved protection and structural integrity. However, fixed roofs limit the versatility of vehicles, particularly in terms of their usability in different weather conditions and environments.

In response to the limitations of fixed roofs, the automotive industry began to experiment with convertible tops in the 1920s and 1930s. These tops were typically made from fabric and could be manually or semi-automatically retracted, allowing vehicles to switch between open and closed configurations. Despite their popularity, early convertible tops had significant drawbacks. They were prone to damage due to overuse, provided limited insulation against noise and weather, and often required considerable effort to operate. These limitations spurred further innovation in the development of removable tops.

The mid-20th century saw significant advancements in the design and functionality of removable tops, particularly with the introduction of hardtops that could be detached or retracted. Unlike fabric tops, hardtops were typically made from metal or composite materials, providing superior protection against the elements, better sound insulation, and enhanced security. Removable hardtops offered a blend of the benefits of fixed roofs and convertibles. They provided the robustness and insulation of a fixed roof while allowing the option to remove the top for an open-air experience. These tops were particularly popular in sports cars and luxury vehicles, where performance and aesthetics were key considerations. The development of the removable hardtop also saw the introduction of various mechanisms to facilitate easier removal, storage, and reinstallation.

Modern removable tops may feature lightweight composite materials, which reduce the effort required for removal and installation, and advanced latching systems that ensure a secure fit with minimal user intervention. Additionally, the introduction of retractable hardtops, many of which can be stowed within the vehicle's trunk at the push of a button, has further blurred the line between convertibles and fixed-roof vehicles. These systems offer the convenience of a convertible with the security and durability of a hardtop.

However, many modern vehicles still do not offer the convenience of storing the hardtop within itself. These vehicles often have hardtops larger than the space available to store them. Since they cannot be stored within the vehicle itself this produces a major issue of where the hardtops can be conveniently stored and easily transportable to facilitate reattachment. Accordingly, it is the object of this disclosure to present a hardtop storage device that allows the hardtop to be easily available and easily storable.

### SUMMARY OF THE DISCLOSURE

Disclosed herein is a hardtop storage device.

### BRIEF DESCRIPTION OF THE DRAWINGS

Non-limiting and non-exhaustive implementations of the disclosure are described with reference to the following figures, wherein similar reference numerals refer to similar parts throughout the various views unless otherwise specified. The advantages of the disclosure will become better understood with regard to the following description and accompanying drawings where:

FIG. 1 illustrates a front perspective view of a hardtop storage device.

FIG. 2 illustrates a side perspective view of a hardtop storage device.

FIG. 3 illustrates a top perspective view of the disconnected pieces of a hardtop storage device.

FIG. 4 illustrates a front perspective view of an occupied hardtop storage device.

### DETAILED DESCRIPTION

In the following description of the disclosure, reference is made to the accompanying drawings, which form a part hereof, and in which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same or similar reference numbers are used throughout the drawings to refer to the same or similar parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

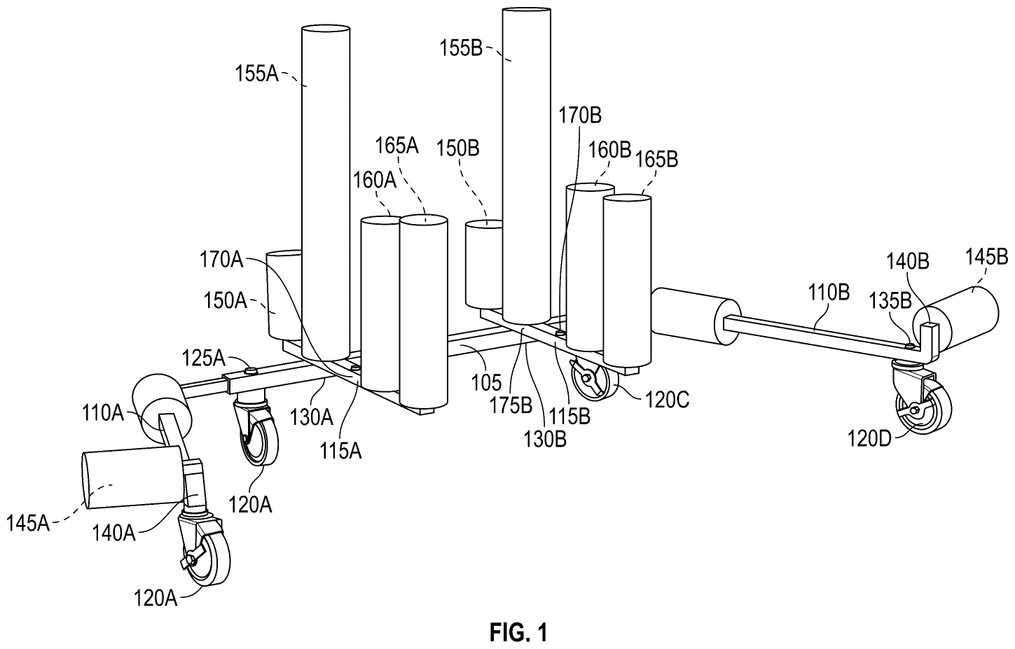

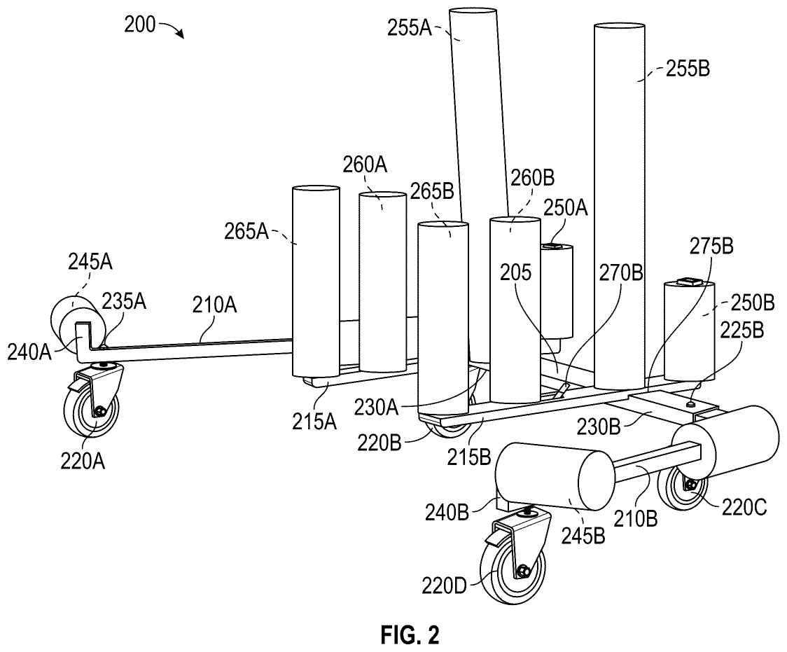

FIG. 1 illustrates a front perspective view of hardtop storage device 100. Storage device 100 may include central frame 105. Central frame 105 at one end may attach to side frame 110A at frame junction 125A. At another end central frame 105 may attach to side frame 110B at a frame junction (not seen due to perspective but similar to frame junction 225B as seen in FIG. 2). A portion of side frame 110A, when attached to central frame 105 at frame junction 125A, may extend in the same direction as central frame 105. Side frame 110A may include a bend in its framework after the portion that extends in the same direction as central frame 105. Along the length of side frame 110A after the bend and along the length of central frame 105 may create an angle greater than 90 degrees. Side frame 110A may be a mirror image of side frame 110B such that side frame 110B may include a bend in its framework after the portion that extends in the same direction as central frame 105 in a similar but opposite fashion. The angle created between side frame 110B and central frame 105 after the bend may create an angle greater than 90 degrees. Accordingly, when side frames 110A-B are both attached to central frame 105 side frame 110A may extend away from side frame 110B.

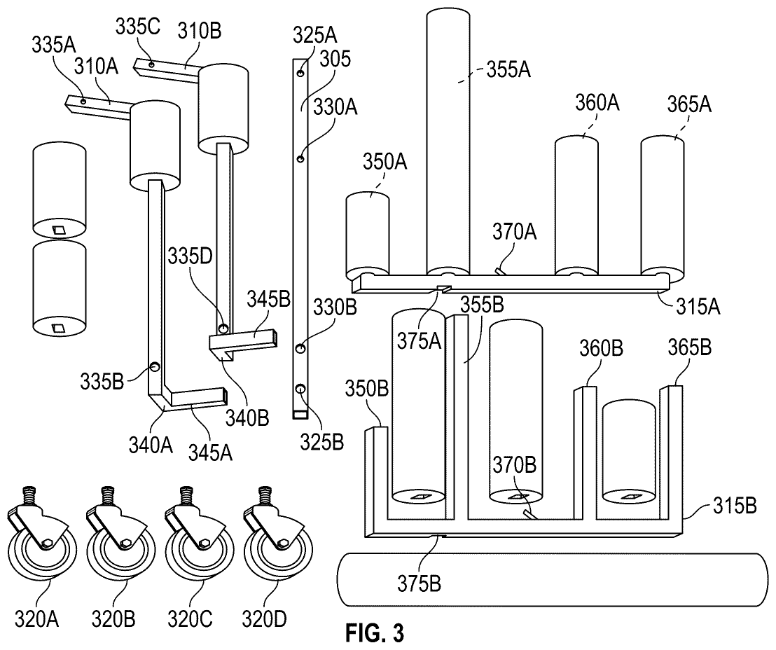

Side frame 110A may also include wheel 120B at frame junction 125A. Wheel 120B may attach near to side frame 110A and central frame 105 near a first end of both side frame 110A and central frame 105. Wheel 120A may also attach to side frame 110A at wheel linkage 135A (similar to 235A as seen in FIGS. 2 and 325A as seen in FIG. 3) near a second end of side frame 110A. Side frame 110A may also include vertical branch 140A connecting to side frame 110A nearer to the second end of side frame 110A than where wheel 120A is attached. Vertical branch 140A may extend upwards from side frame 110A. The upper portions of vertical branch 140A may attach to horizontal branch 145A and extend outward in a manner that is substantially perpendicular to the length of side frame 110A. Substantially in this context means plus or minus 5%.

Side frame 110A may also include padding positioned in various locations to protect the removed hardtops. For example, a pad may be placed after but near the first bend of side frame 110A. Accordingly, the pad may be located close to the first end of side frame 110A. Another foam pad may be placed on horizontal branch 145A near and/or at the second end of side frame 110A. Alternatively, pads may be placed along the entire portion of side frame 110A. Pads may be comprised of natural and/or synthetic material meant to help protect the removed hardtops when positioned on storage device 100.

Side frame 110B may also include wheel 120C at the frame junction (similar to 235B as seen in FIGS. 2 and 335B as seen in FIG. 3). Wheel 120C may attach near to side frame 110B and central frame 105 near a first end of side frame 110B and a second end of central frame 105. Wheel 120D may also attach to side frame 110B at the wheel linkage 135B near a second end of side frame 110B. Side frame 110B may also include vertical branch 140B connecting to side frame 110B nearer to the second end of side frame 110B than where wheel 120D is attached. Vertical branch 140B may extend upwards from side frame 110B. The upper portion of vertical branch 140B may attach to horizontal branch 145B and extend outward in a manner that is substantially perpendicular to the length of side frame 110B.

Substantially in this context means plus or minus 5%. Side frame 110B may also include padding positioned in various locations to protect the removed hardtops. For example, a pad may be placed after but near the first bend of side frame 110B. The pad may be located close to the first end of side frame 110B. Another pad may be placed on horizontal branch 145B near and/or at the second end of side frame 110B. Alternatively, pads may be placed along the entire portion of side frame 110B. The pads may be comprised of natural and/or synthetic material meant to help protect the removed hardtops when positioned on storage device 100.

Central frame 105 may attach to the bottom portion of support arms 115A-B. Support arm 115A may attach to central frame 105 at linkage 130A positioned towards the center point between the first and second ends of central frame 105 as compared to frame junction 125A. Support arms 115A-B may also include various braces that extend upwards from support arms 115A-B. For example, support arm 115A may include back brace 150A positioned near a first end of support arm 115A. Back brace 150A may be the shortest of all the braces on support arm 115A. Support arm 115A may also include tall brace 155A positioned next to back brace 150A but closer to the midpoint between the first and second ends of support arm 115A. Tall brace 155A may be double the height of any of braces 150A, 160A, or 165A. Support arm 115A may also include front brace 165A positioned near the second end of support arm 115A. Front brace 165A may be taller than back brace 150A but shorter than tall brace 155A. Support arm 115A may also include middle brace 160A. Middle brace 160A may be positioned between tall brace 155A and front brace 165A. Middle brace 160A may be taller than back brace 150A but shorter than tall brace 155A. Middle brace 160A may be substantially the same height as front brace 165A. Substantially in this context means plus or minus 5%.

Support arm 115A may also include gap 175A that may be positioned on the underside of support arm 115A between back brace 150A and tall brace 155A. Gap 175A may be used to facilitate linkage 130A. Support arm 115A may also include catch 170A positioned on the top side of support arm 115A in between tall brace 155A and middle brace 160A. Catch 170A may help a hardtop to remain closer to either tall brace 155A or middle brace 160A. Braces 150A, 155A, 160A, and 165A may be enveloped or surrounded by pads. The pads may be comprised of natural and/or synthetic material meant to help protect the removed hardtops when positioned on storage device 100.

Similarly, support arm 115B may attach to central frame 105 at linkage 130B. Linkage 130B may be positioned towards a center point between the first and second ends of center frame 105 as compared to the frame junction 125B. Support arm 115B may attach to central frame 105 at linkage 130B. Linkage 130B may be positioned towards the center point between the first and second ends of central frame 105 as compared to the frame junction. Support arm 115B may include back brace 150B which may be positioned near a first end of support arm 115B. Back brace 150B may be the shortest of all the braces attached to support arm 115B. Support arm 115B may also include tall brace 155B positioned next to back brace 150B but closer to the midpoint between the first and second ends of support arm 115B. Tall brace 155B may be double the height of any of braces 150B, 160B, 165B. Support arm 115B may also include front brace 165B positioned near the second end of support arm 115B. Front brace 165B may be taller than back brace 150B but shorter than tall brace 155B. Support arm 115B may also include middle brace 160B. Middle brace 160B may be positioned between tall brace 155B and front brace 165B. Middle brace 160B may be taller than back brace 150B but shorter than tall brace 155B. Middle brace 160B may be substantially the same height as front brace 165B. Substantially, in this context means plus or minus 5%.

Support arm 115B may also include gap 175B that may be positioned on the underside of support arm 115B between back brace 150B and tall brace 155B. Gap 175B may be used to facilitate linkage 130B. Support arm 115B may also include catch 170B positioned between tall brace 155B and middle brace 160B. Catch 170B may help a hardtop to remain closer to either tall brace 155B or middle brace 160B. Braces 150B, 155B, 160B, and 165B may be enveloped or surrounded by pads. The pads may be comprised of natural and/or synthetic material meant to help protect the removed hardtops when positioned on storage device 100.

FIG. 2 illustrates a side perspective view of hardtop storage device 200. Storage device 200 may include central frame 205. Central frame 205 at one end may attach to side frame 210A at frame junction 225A. At another end central frame 205 may attach to side frame 210B at frame junction 225B. A portion of side frame 210A, when attached to central frame 205 at frame junction 225A, may extend in the same direction as central frame 205. Side frame 210A may include a bend in its framework after the portion that extends in the same direction as central frame 205. The angle created between side frame 210A after the bend and central frame 205 may create an angle greater than 90 degrees. Side frame 210A may be a mirror image of side frame 210B such that side frame 210B may include a bend in its framework after the portion that extends in the same direction as central frame 205. Side frame 210B may include a bend in its framework after the portion that extends in the same direction as central frame 205. The angle created between side frame 210B and central frame 205 after the bend may create an angle greater than 90 degrees. Accordingly, when side frames 210A-B are both attached to central frame 205 side frame 210A may extend away from side frame 210B.

Side frame 210A may also include wheel 220B at frame junction 225A. (similar to 125A as seen in FIG. 1 and 325A as seen in FIG. 3). Wheel 220B may attach near to side frame 210A and central frame 205 near a first end of both side frame 210A and central frame 205. Wheel 220A may also attach to side frame 210A at wheel linkage 235A near a second end of side frame 210A. Side frame 210A may also include vertical branch 240A connecting to side frame 210A nearer to the second end of side frame 210A than where wheel 220A is attached. Vertical branch 240A may extend upwards from side frame 210A. The upper portions of vertical branch 240A may attach to horizontal branch 245A and extend outward substantially perpendicular to the length of side frame 210A. Substantially in this context means plus or minus 5%. Side frame 210A may also include padding positioned in various locations to protect the removed hardtops. For example, a pad may be placed after but near the first bend. The pad may be located close to the first end of side frame 210A. Another foam pad may be placed on horizontal branch 245A near and/or at the second end of side frame 210A. Alternatively, pads may be placed along the entire portion of side frame 210A. Pads may be comprised of natural and/or synthetic material meant to help protect the removed hardtops when positioned on storage device 200.

Side frame 210B may also include wheel 220C at frame junction 225. Wheel 220C may attach near to side frame 210B and central frame 205 near a first end of side frame 210B and a second end of central frame 205. Wheel 220D may also attach to side frame 210B at wheel linkage 235B near a second end of side frame 210B. Side frame 210B may also include vertical branch 240B connecting to side frame 210B nearer to the second end of side frame 210B than where wheel 220D is attached. Vertical branch 240B may extend upwards from side frame 210B. The upper portions of vertical branch 240B may attach to horizontal branch 245B and extend outward substantially perpendicular to the length of side frame 210B. Substantially in this context means plus or minus 5%. Side frame 210B may also include padding positioned in various locations to protect the removed hardtops. For example, a pad may be placed after but near the first bend of side frame 210B. The pad may be located close to the first end of side frame 210B. Another pad may be placed on horizontal branch 245B near and/or at the second end of side frame 210B. Alternatively, pads may be placed along the entire portion of side frame 210B. The pads may be comprised of natural and/or synthetic material meant to help protect the removed hardtops when positioned on storage device 200.

Central frame 205 may attach to the bottom portion of support arms 215A-B. Support arm 215A may attach to central frame 205 at linkage 230A positioned towards the center point between the first and second ends of central frame 205 as compared to frame junction 225A. Support arms 215A-B may also include various braces that extend upwards from support arms 215A-B. For example, support arm 215A may include back brace 250A positioned near a first end of support arm 215A. Back brace 250A may be the shortest of all the braces attached to support arm 215A. Support arm 215A may also include tall brace 255A positioned next to back brace 250A but closer to the midpoint between the first and second ends of support arm 215A. Tall brace 255A may be double the height of any of the braces attached to support arm 215A. Support arm 215A may also include front brace 265A positioned near the second end of support arm 215A. Front brace 265A may be taller than back brace 250A but shorter than tall brace 255A. Support arm 215A may also include middle brace 260A. Middle brace 260A may be positioned between tall brace 255A and front brace 265A. Middle brace 260A may be taller than back brace 250A but shorter than tall brace 255A. Middle brace 260A may be substantially the same height as front brace 265A. Substantially in this context means plus or minus 5%.

Support arm 215A may also include a gap (not seen due to perspective) that may be positioned on the underside of support arm 215A between back brace 250A and tall brace 255A. The gap may be used to facilitate linkage 230A. Support arm 215A may also include a catch (not seen due to perspective but similar to catch 170A as seen in FIG. 1) positioned in between tall brace 255A and middle brace 260A. The catch may help a hardtop to remain closer to either tall brace 255A or middle brace 260A. Braces 250A, 255A, 260A, and 265A may be enveloped or surrounded by pads. The pads may be comprised of natural and/or synthetic material meant to help protect the removed hardtops when positioned on storage device 200.

Similarly, support arm 215B may attach to central frame 205 at linkage 230B positioned towards the center point between the first and second ends of central frame 205 as compared to frame junction 225B. Support arm 215B may attach to central frame 205 at linkage 230B positioned towards the center point between the first and second ends of central frame 205 as compared to frame junction 225B. Support arm 215B may include back brace 250B positioned near a first end of support arm 215B. Back brace 250B may be the shortest of all the braces attached to support arm 215B. Support arm 215B may also include tall brace 255B positioned next to back brace 250B but closer to the midpoint between the first and second ends of support arm 215B. Tall brace 255B may be double the height of any of the braces attached to support arm 215B. Support arm 215B may also include front brace 265B positioned near the second end of support arm 215B. Front brace 265B may be taller than back brace 250B but shorter than tall brace 255B. Support arm 215B may also include middle brace 260B. Middle brace 260B may be positioned between tall brace 255B and front brace 265B. Middle brace 260B may be taller than back brace 250B but shorter than tall brace 255B. Middle brace 260B may be substantially the same height as front brace 265B. Substantially in this context means plus or minus 5%.

Support arm 215B may also include gap 275B that may be positioned on the underside of support arm 215B between back brace 250B and tall brace 255B. Gap 275B may be used to facilitate linkage 230B. Support arm 215B may also include catch 270B positioned in between tall brace 255B and middle brace 260B. Catch 270B may help a hardtop to remain closer to either tall brace 255B or middle brace 260B. Braces 250B, 255B, 260B, and 265B may be enveloped or surrounded by pads. The pads may be comprised of natural and/or synthetic material meant to help protect the removed hardtops when positioned on storage device 200.

FIG. 3 illustrates a top perspective view of the disconnected pieces of hardtop storage device 300. Storage device 300 may include central frame 305. Central frame 305 at one end may attach to side frame 310A at frame junction 325A. At another end central frame 305 may attach to side frame 310B at frame junction 325B. A portion of side frame 310A, when attached to central frame 305 at frame junction 325A, may extend in the same direction as central frame 305. Side frame 310A may include a bend in its framework after the portion that extends in the same direction as central frame 305. When attached, the angle created between side frame 310A after the bend and central frame 305 may create an angle greater than 90 degrees. Side frame 310A may be a mirror image of side frame 310B such that side frame 310B, when attached, may include a bend in its framework after the portion that extends in the same direction as central frame 305. Side frame 310B may include a bend in its framework after the portion that extends in the same direction as central frame 305. The angle created between side frame 310B and central frame 305 after the bend may create an angle greater than 90 degrees. Accordingly, when side frames 310A-B are both attached to central frame 305 side frame 310A may extend away from side frame 310B.

Side frame 310A may also include wheel 320B at frame junction 325A. Wheel 320B may attach near to side frame 310A and central frame 305 near a first end of both side frame 310A and central frame 305. Wheel 320A may also attach to side frame 310A at wheel linkage 335A near a second end of side frame 310A. Side frame 310A may also include vertical branch 340A connecting to side frame 310A nearer to the second end of side frame 310A than where wheel 320A is attached. Vertical branch 340A may extend upwards from side frame 310A. The upper portions of vertical branch 340A may attach to horizontal branch 345A and extend outward substantially perpendicular to the length of side frame 310A. Substantially in this context means plus or minus 5%. Side frame 310A may also include padding positioned in various locations to protect the removed hardtops. For example, a pad may be placed after but near the first bend. The pad may be located close to the first end of side frame 310A. Another foam pad may be placed on horizontal branch 345A near and/or at the second end of side frame 310A. Alternatively, pads may be placed along the entire portion of side frame 310A. Pads may be comprised of natural and/or synthetic material meant to help protect the removed hardtops when positioned on storage device 300.

Side frame 310B may also include wheel 320C at frame junction 325. Wheel 320C may attach near to side frame 310B and central frame 305 near a first end of side frame 310B and a second end of central frame 305. Wheel 320D may also attach to side frame 310B at wheel linkage 335B near a second end of side frame 310B. Side frame 310B may also include vertical branch 340B connecting to side frame 310B nearer to the second end of side frame 310B than where wheel 320D is attached. Vertical branch 340B may extend upwards from side frame 310B. The upper portions of vertical branch 340B may attach to horizontal branch 345B and extend outward substantially perpendicular to the length of side frame 310B.

Substantially in this context means plus or minus 5%. Side frame 310B may also include padding positioned in various locations to protect the removed hardtops. For example, a pad may be placed after but near the first bend of side frame 310B. The pad may be located close to the first end of side frame 310B. Another pad may be placed on horizontal branch 345B near and/or at the second end of side frame 310B. Alternatively, pads may be placed along the entire portion of side frame 310B. The pads may be comprised of natural and/or synthetic material meant to help protect the removed hardtops when positioned on storage device 300.

Central frame 305 may attach to the bottom portion of support arms 315A-B. Support arm 315A may attach to central frame 305 at linkage 330A positioned towards the center point between the first and second ends of central frame 305 as compared to frame junction 325A. Support arms 315A-B may also include various braces that extend upwards from support arms 315A-B. For example, support arm 315A may include back brace 350A positioned near a first end of support arm 315A. Back brace 350A may be the shortest of all the braces attached to support arm 315A. Support arm 315A may also include tall brace 355A positioned next to back brace 350A but closer to the midpoint between the first and second ends of support arm 315A. Tall brace 355A may be double the height of any of the braces attached to support arm 315A. Support arm 315A may also include front brace 365A positioned near the second end of support arm 315A. Front brace 365A may be taller than back brace 350A but shorter than tall brace 355A. Support arm 315A may also include middle brace 360A. Middle brace 360A may be positioned between tall brace 355A and front brace 365A. Middle brace 360A may be taller than back brace 350A but shorter than tall brace 355A. Middle brace 360A may be substantially the same height as front brace 365A. Substantially in this context means plus or minus 5%.

Support arm 315A may also include gap 375A that may be positioned on the underside of support arm 315A between back brace 350A and tall brace 355A. Gap 375A may be used to facilitate linkage 130A. Support arm 315A may also include catch 370A positioned in between tall brace 355A and middle brace 360A. Catch 370A may help a hardtop to remain closer to either tall brace 355A or middle brace 360A. Braces 350A, 355A, 360A, and 365A may be enveloped or surrounded by pads. The pads may be comprised of natural and/or synthetic material meant to help protect the removed hardtops when positioned on storage device 300.

Similarly, support arm 315B may attach to central frame 305 at linkage 330B positioned towards the center point between the first and second ends of central frame 305 as compared to frame junction 325B. Support arm 315B may attach to central frame 305 at linkage 330B positioned towards the center point between the first and second ends of central frame 305 as compared to frame junction 325B. Support arm 315B may include back brace 350B positioned near a first end of support arm 315B. Back brace 350B may be the shortest of all the braces attached to support arm 315B. Support arm 315B may also include tall brace 355B positioned next to back 350B but closer to the midpoint between the first and second ends of support arm 315B. Tall brace 355B may be double the height of any of the braces attached to support arm 315B. Support arm 315B may also include front brace 365B positioned near the second end of support arm 315B. Front brace 365B may be taller than back brace 350B but shorter than tall brace 355B. Support arm 315B may also include middle brace 360B. Middle brace 360B may be positioned between tall brace 355B and front brace 365B. Middle brace 360B may be taller than back brace 350B but shorter than tall brace 355B. Middle brace 360B may be substantially the same height as front brace 365B. Substantially in this context means plus or minus 5%.

Support arm 315B may also include gap 375B that may be positioned on the underside of support arm 315B between back brace 350B and tall brace 355B. Gap 375B may be used to facilitate linkage 130A. Support arm 315B may also include catch 370B positioned in between tall brace 355B and middle brace 360B. Catch 370B may help a hardtop to remain closer to either tall brace 355B or middle brace 360B. Braces 350B, 355B, 360B, and 365B may be enveloped or surrounded by pads. The pads may be comprised of natural and/or synthetic material meant to help protect the removed hardtops when positioned on storage device 300.

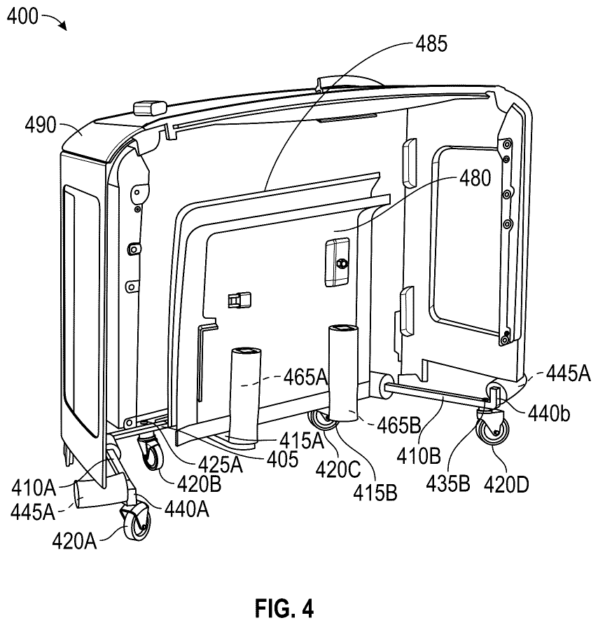

FIG. 4 illustrates a front perspective view of storage device 400 with hardtops 480, 485, and 490. Central frame 405 at one end may attach to side frame 410A at frame junction 425A. At another end central frame 405 may attach to side frame 410B at a frame junction. The Frame junction is not depicted due to the perspective but is similar to frame junctions 225B and 325B depicted in FIGS. 2 and 3. A portion of side frame 410A, when attached to central frame 405 at junction 425A, may extend in the same direction as central frame 405. Side frame 410A may include a bend in its framework after the portion that extends in the same direction as central frame 405. This bend is not depicted due to perspective but is similar to the bend in side frames 110A and 310A as depicted in FIGS. 1 and 3. The angle created between side frame 410A after the bend and central frame 405 may create an angle greater than 90 degrees. Side frame 410A may be a mirror image of side frame 410B such that side frame 410B may include a bend in its framework after the portion that extends in the same direction as central frame 405. Side frame 410B may include a bend in its framework after the portion that extends in the same direction as central frame 405. The shape of side frame 410B is not fully depicted due to the presented perspective however the shape of side frame 410B is similar to side frames 210B and 310B as depicted in FIGS. 2 and 3. The angle created between side frame 410B and central frame 405 after the bend may create an angle greater than 90 degrees. Accordingly, when side frames 410A-B are both attached to central frame 405 side frame 110A may extend away from side frame 410B.

Side frame 410A may also include wheel 420B at frame junction 425A. Wheel 420B may attach near to side frame 410A and central frame 405 near a first end of both side frame 410A and central frame 405. Wheel 420A may also attach to side frame 410A at wheel linkage (similar to 235A as seen in FIGS. 2 and 325A as seen in FIG. 3) near a second end of side frame 410A. Side frame 410A may also include vertical branch 440A connecting to side frame 410A nearer to the second end of side frame 410A than where wheel 420A is attached. Vertical branch 440A may extend upwards from side frame 410A. The upper portions of vertical branch 440A may attach to horizontal branch 445A and extend outward substantially perpendicular to the length of side frame 410A. Substantially in this context means plus or minus 5%. Side frame 410A may also include padding positioned in various locations to protect removed hardtops 480, 485, and 490. For example, a pad may be placed after but near the first bend. The pad may be located close to the first end of side frame 410A. Another foam pad may be placed on horizontal branch 445A near and/or at the second end of side frame 410A. Alternatively, pads may be placed along the entire portion of side frame 410A. Pads may be comprised of natural and/or synthetic material meant to help protect hardtops 480, 485, and 490 when positioned on storage device 400.

Side frame 410B may also include wheel 420C at the frame junction (similar to 125B as seen in FIGS. 2 and 325B as seen in FIG. 3). Wheel 420C may attach near to side frame 410B and central frame 405 near a first end of side frame 410B and a second end of central frame 405. Wheel 420D may also attach to side frame 410B at wheel linkage 435B near a second end of side frame 410B. Side frame 410B may also include vertical branch 440B connecting to side frame 410B nearer to the second end of side frame 410B than where wheel 420D is attached. Vertical branch 440B may extend upwards from side frame 410B. The upper portions of vertical branch 440B may attach to horizontal branch 445B and extend outward substantially perpendicular to the length of side frame 410B. Substantially in this context means plus or minus 5%. Side frame 410B may also include padding positioned in various locations to protect removed hardtops 480, 485, and/or 490. For example, a pad may be placed after but near the first bend of frame 410B. The pad may be located close to the first end of side frame 410B. Another pad may be placed on horizontal branch 445B near and/or at the second end of side frame 410B. Alternatively, pads may be placed along the entire portion of side frame 410B. The pads may be comprised of natural and/or synthetic material meant to help protect removed hardtops 480, 485, and 490 when positioned on storage device 400.

Central frame 405 may attach to the bottom portion of support arms 415A-B. Depictions of many parts of storage device 400 including support arms 415A-B are not available due to perspective however similar parts with similar numbers are depicted in FIGS. 1, 2, and 3. Support arm 415A may attach to central frame 405 at linkage 430A positioned towards the center point between the first and second ends of central frame 405 as compared to frame junction 425A. Support arms 415A-B may also include various braces that extend upwards from support arms 415A-B. For example, support arm 415A may include a back brace positioned near a first end of support arm 415A. The back brace may be the shortest brace attached to support arm 415A. Also, the linkage of the attachment point (similarly depicted as 130A in FIG. 1) may be positioned between the back brace and the tall brace. Support arm 415A may also include a tall brace positioned next to the back brace but closer to the midpoint between the first and second ends of support arm 415A. The tall brace may be double the height of any of the braces on support arm 415A. Support arm 415A may also include front brace 465A positioned near the second end of support arm 415A. Front brace 465A may be taller than the back brace but shorter than the tall brace. Support arm 415A may also include a middle brace. The middle brace may be positioned between the tall brace and front brace 465A. The middle brace may be taller than the back brace but shorter than the tall brace. The middle brace may be substantially the same height as front brace 465A. Substantially in this context means plus or minus 5%.

Support arm 415A may also include a catch positioned in between the tall brace and the middle brace. For example, the catch may help hardtop 485 to remain closer to either the tall brace or the middle brace. The braces may be enveloped or surrounded by pads. The pads may be comprised of natural and/or synthetic material meant to help protect the removed hardtops 480, 485, and/or 490 when positioned on storage device 400. Furthermore, any portion of storage device 400 may be padded to protect removed hardtops 480, 485, and 490.

Similarly, support arm 415B may attach to central frame 405 at the linkage (not depicted due to perspective but similar to linkage 230B and 330B in FIGS. 2 and 3) positioned towards the center point between the first and second ends of central frame 405 as compared to the frame junction (not depicted due to perspective but similar to frame junction 225B and 325B in FIGS. 2 and 3). Support arm 415B may attach to central frame 405 at a linkage positioned towards the center point between the first and second ends of central frame 405 as compared to frame junction. Support arm 415B may include a back brace positioned near a first end of support arm 415B. The back brace may be the shortest of all the braces on support arm 415B. Support arm 415B may also include a tall brace positioned next to the back brace but closer to the midpoint between the first and second ends of support arm 415B. The tall brace may be double the height of any of the braces attached to support arm 415B. Support arm 415B may also include front brace 465B positioned near the second end of support arm 415B. Front brace 465B may be taller than the back brace but shorter than the tall brace. Support arm 415B may also include a middle brace. The middle brace may be positioned between the tall brace and front brace 465B. The middle brace may be taller than the back brace but shorter than the tall brace. The middle brace may be substantially the same height as front brace 465B. Substantially in this context means plus or minus 5%.

Support arm 415B may also include a catch (not seen due to perspective but similar to 170B, 270B, and 370B in FIGS. 1, 2, and 3) positioned in between the tall brace and the middle brace. The catch may help a hardtop 485 to remain closer to either the tall brace or the middle brace. The braces may be enveloped or surrounded by pads. The pads may be comprised of natural and/or synthetic material meant to help protect removed hardtops 480, 485, and/or 490 when positioned on storage device 400. Furthermore, any portion of storage device 400 may be padded to protect removed hardtops 480, 485, and 490.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A hardtop storage device comprising:
a central frame comprising:
a wheel,
a first support arm attaching to the central frame comprising:
a brace attaching to the first support arm;
a second support arm attaching to the central frame comprising:
a brace attaching to the second support arm;
a first side frame attaching to a first end of the central frame comprising:
a wheel,
a horizontal branch;
a second side frame attached to a second end of the central frame comprising:
a wheel, and
a horizontal branch.

2. The hardtop storage device of claim 1, wherein the first side frame and the second side frame extend away from each other extending outward from their respective attachment to the central frame.

3. The hardtop storage device of claim 1, wherein the first side frame further comprises:
a vertical branch.

4. The hardtop storage device of claim 3, wherein the vertical branch attaches to the horizontal branch on one end and attaches to the first side frame on the other end.

5. The hardtop storage device of claim 1, wherein the second side frames further comprises:
a vertical branch.

6. The hardtop storage device of claim 3, wherein the vertical branch attaches to the horizontal branch on one end and attaches to the second side frame on the other end.

7. The hardtop storage device of claim 1, wherein the first side frame comprises:
a bend.

8. The hardtop storage device of claim 1, wherein the first side frame attaches to the first end central frame at the end nearest the bend of the first side frame.

9. The hardtop storage device of claim 1, wherein the second side frame comprises:
a bend.

10. The hardtop storage device of claim 7, wherein the second side frame attaches to the second end central frame at the end nearest the bend of the second frame.

11. The hardtop storage device of claim 1, wherein the first support arm comprises a plurality of braces.

12. The hardtop storage devices of claim 11, wherein the first support arm comprises:
a plurality of braces.

13. The hardtop storage devices of claim 12, wherein the second support arm comprises:
a plurality of braces.

14. The hardtop storage devices of claim 13, wherein one of the plurality of braces, of the first support arm, is taller than the other braces.

15. The hardtop storage devices of claim 14, wherein one of the plurality of braces, of the second support arm, is taller than the other braces.

16. The hardtop storage devices of claim 15, wherein one of the plurality of braces, of the first support arm, is shorter than the other braces.

17. The hardtop storage devices of claim 16, wherein one of the plurality of braces, of the second support arm, is shorter than the other braces.

18. The hardtop storage devices of claim 17, wherein two of the plurality of braces, of the first support arm, are substantially the same height.

19. The hardtop storage devices of claim 18, wherein two of the plurality of braces, of the second support arm, are substantially the same height.

20. The hard top of storage device of claim 12, wherein the space between the plurality of braces of both the first and second support arms are sized to fit a hardtop in a manner that allows a back window of the hard top to face upwards away from the hard top storage device.
